(19) United States
(12) Patent Application Publication
(10) Pub. No.: US 2002/0136538 A1
(43) Pub. Date: Sep. 26, 2002

(54) Smart quality setting for personal TV recording

(75) Inventor: Yingwei Chen, Briarcliff Manor, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/814,656

(22) Filed: Mar. 22, 2001

(51) Int. Cl. H04N 5/92; H04N 5/781

(52) U.S. Cl. 386/111; 386/125

(57) ABSTRACT

An apparatus for automatically adjusting the recording quality of incoming video data is provided. The apparatus includes a content analyzer for evaluating an incoming stream of video programs; a recording manager for determining the target recording bit rate according to the type of video programs received by the content analyzing device, a bit rate controller for adjusting the recording bit rate of the incoming video stream, an encoder/transcoder device for transforming the incoming video programs into a video stream at a specified bit rate designated by the bit rate controller, and a disk storage medium for storing video programs provided by the encoder/transcoder device. The method includes the steps of: analyzing the content of incoming video information representative of dynamic video signal streams; determining an appropriate bit rate for recording in the storage medium according to predetermined criteria; and, recording the incoming video information representative of dynamic video signal streams according to the determined bit rate.

### BACKGROUND OF THE INVENTION

1. Field of Invention

The present invention is related to information management systems, and more particularly, to a method and system for automatically setting the recording quality for the stream of incoming video programs.

2. Description of Related Arts

Both ReplayTV (trademark of REPLAY NETWORKS, INC., of Palo Alto, Calif.) and TiVo (trademark of TIVO, Inc., of Sunnyvale, Calif.) are the first wave of a new type of “VCR” that gives the television viewer new abilities to capture and manipulate the stream of television shows, which flow from their cable and satellite systems. These personal television devices act as a personal assistant by changing channels for viewers, recording programs that interest the viewers, and assisting the viewers to watch the recorded programs when they wish. Both devices have the ability to pause/rewind television shows as they are broadcast, to watch a recorded program while recording another, to record for both short and long-term archival, and other related features including an electronic program guide (EPG), time-shifted viewing, and unattended recording of programs.

Typically, the recording feature of the above-described personal TV recorders allows timed recordings in the 15-hour range or better. For this purpose, a disk storage is provided in these recorders where compressed forms of video programs can be stored. The amount of storage space required in the disk space for recording depends on the level of the video quality being compressed. For example, in TiVo, four levels of quality setting (basic, medium, high and best) are supported to provide users the flexibility in trading off the quality for recording capacity. If higher quality recording were selected, more disk storage room is required. Hence, the recording quality can directly affect the length of video that the same disk storage can hold.

Currently, the provision of quality setting in the personal TV recording devices is set by users manually. That is, users determine before recording per program series, by default or on-the-fly, what quality setting to use. However, this is inconvenient for the users, especially if the personal TV box is programmed for time-shifting when or if a variety of programmings is to be recorded while the user is not home when the recording is occurring. Once the recording mode is selected, users are limited to the setting until user intervention is possible. As the users are not able to change the quality of setting, most viewers are unable to take advantage of better utilization of the limited disk space by controlling the space/quality tradeoff.

### SUMMARY OF THE INVENTION

The present invention relates to an intelligent video information management system with automatic quality setting capabilities to efficiently utilize the limited disk storage space in the personal TV recorders.

According to an aspect of the invention, there is provided a quality setting apparatus, which includes a content analyzer for evaluating the incoming stream of incoming video programs; a recording manager for determining the target recording bit rate according to the type of video programs received by the content analyzing device, a bit rate controller for adjusting the recording bit rate of the incoming video stream, an encoder/transcoder device for compressing the incoming video programs into a video stream at a specified bit rate designated by the bit rate controller, and a disk storage medium for storing the compressed video programs.

According to another aspect of the invention, there is provided a method of automatically setting the recording quality of streams of incoming video programs, the method including the steps of: analyzing the content of incoming video information representative of dynamic video signal streams; determining an appropriate bit rate for recording in a storage medium according to predetermined criteria; and, recording the incoming video information representative of dynamic video signal streams according to the determined bit rate.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments which depart from these specific details. Moreover, for the purpose of clarity, detailed descriptions of well-known devices, circuits, and methods are omitted so as not to obscure the description of the present invention with unnecessary detail.

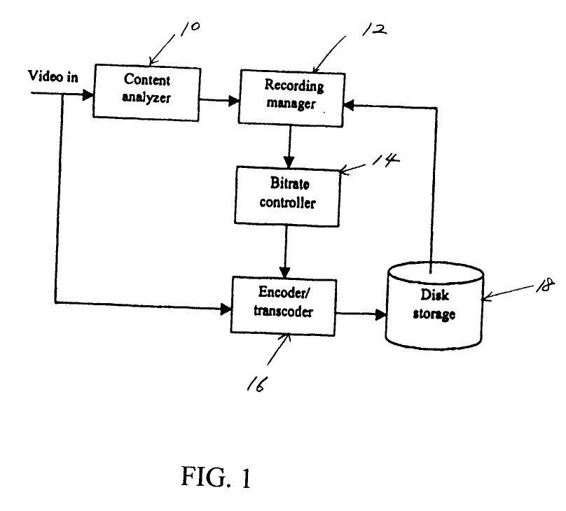

FIG. 1 illustrates an information management system for automatically adjusting the recording quality setting according to the embodiment of the present invention. The apparatus includes a content analyzer 10 for classifying the type of video programs into a plurality of categories; a recording manager 12 for determining the recording quality level according to the analysis outcome; a bit rate controller 14 setting an appropriate bit rate that is determined by the recording manager 12; an encoder/transcoder 16 for formatting the video information at the specified bit rate designated by the bit rate controller 14, and a disk storage 18 for storing the output of the encoder/transcoder 16 in a form suitable for subsequent transmission. Here, the data stream received by the analyzer 10 is normally of a fixed bit rate, which is a function of the particular data transmission format. Thus, in accordance with the present invention, recording at a different quality mode is achieved by reducing the amount of data needed to represent images or pictures to produce a reduced rate bit stream from the full rate bit stream received by the content analyzer 12. It should be noted that the present invention may be adapted to provide recording capabilities for both analog signals and digitally encoded signals processed, for example, for compatibility with an MPEG standard and having GA or DSS.TM.

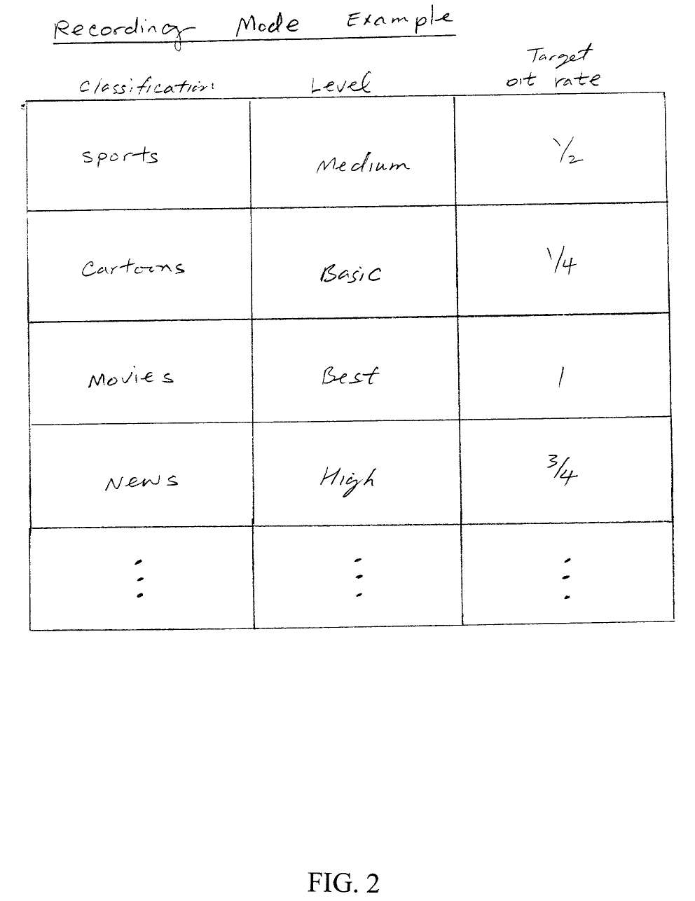

According to the present invention, a stream of video information, including conventional analog TV signals or digital high definition television (HDTV) and/or digital standard definition television (SDTV) signals, is inputted to the content analyzer 10. Upon receiving streams of video programs, the content analyzer 10 determines the type of video shows received therein. For example, the content analyzer 10 classifies the incoming programs into one of the pre-set categories, i.e., sports, cartoons, movies, news, etc. The analysis outcome by the content analyzer 10 is forwarded to the recording manager 12. Meanwhile, based on the classification determined by the content analyzer 10, the recording manager 12 determines the corresponding quality setting mode. That is, each full rate data bit stream received by the receiver is assigned a quality level based on its relative importance in generating a video frame having good image quality. To this end, the recording manager 12 maintains a predetermined table, as shown in FIG. 2, to determine the level of quality setting responsive to the incoming video programs. Here, the table can be pre-set at the manufacturing stage or dynamically changed by the viewers according to their preferences.

Based on the classification of the video programs, the recording manager 12 can select the corresponding target bit rate from the table, as shown in FIG. 2. This figure depicts an example of the parameters used to set the quality according to the present invention. Alternatively, the recording manager 12 determines the portion of available space in the disk storage 18 and makes a decision as to what bit rate is to be set for recording. Then, the recording manager 12 notifies the bit rate controller 14 of the selected target bit rate. The encoder/transcoder 16, under the control of the bit rate controller 14, encodes or transcodes the incoming video programs at the target data rate. Here, analog signals are encoded in accordance with known techniques, and digital signals are transcoded using various known processes ordinarily used, such as an MPEG compression method. The output from the encoder/transcoder is a compressed data stream. Finally, the output of the encoder/transcoder is stored in the disk storage 18. The disk storage 18 can be selected from a group consisting of a rewritable optical disk drive, a DVD drive, a magneto-optical disk drive, and a removable hard disk drive. The data stored in the disk storage 18 may be subsequently converted back to its original form for subsequent viewing.

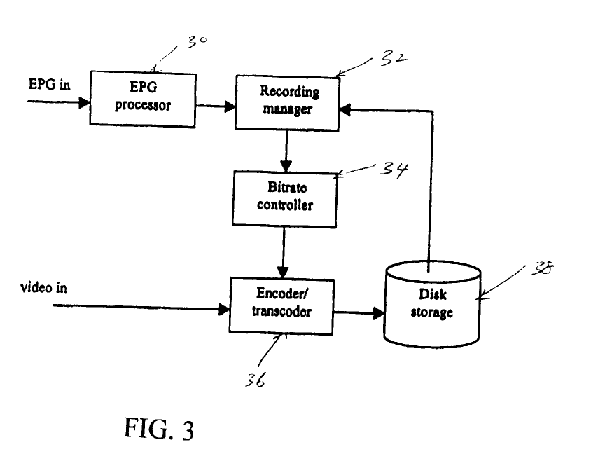

FIG. 3 illustrates another embodiment of the present invention. The system is configured to receive audio/video programs from the conventional television (TV) broadcast 10. The audio/video programs can be delivered in analog, digital or digitally compressed format via any transmission means, including satellite, cable, wire, television broadcast. Video information is input to an EPG processor 30 where the content of the video information is analyzed according to a pre-set classification. To this end, a well-known electronic program guide (EPG) protocol is utilized. An EPG is a standard application designed to aid the viewer in the navigation of and selection from a broadcast material available in a TV environment. The EPG provides information about each program and includes programming characteristics, such as the channel number, program title, start time, end time, elapsed time, time remaining, rating (if available), topic, theme, and a brief description of the program's content. Using the EPG features, the EPG processor 30 can classify the incoming video information into different categories, i.e., sports, cartoons, movies, news, etc.

The outcome of the EPG processor 30 is sent to a recording manager 32 where it is subject to determination according to predetermined criteria, as shown in FIG. 2. This step constitutes a compression control parameter that controls the bit rate. A reduction in the data rate requires that less data be recorded. As the disk space is limited, the use of variable bit rate techniques to reduce the amount of data required to represent a series of images allows for increase in the digital recording time. The speed of the record bit rate is changed for changing the compression ratio depending on the type of video information received therein. Referring to FIG. 2, if sports programs were desired to have a relatively good recording quality, the level of recording quality can be set to record information with the halved bit rate. If cartoon programs were desired to have much lower recording quality, then the bit rate can be halved once more, with a quarter of the original bit rate.

The recording manager 32 retrieves the target bit rate matching the classification that is determined by the EPG processor 30. The target bit rate determined by the recording manager 32 is sent to a bit rate controller 34. Under control of the bit rate controller 34, the encoder/transcoder 36 transforms the incoming video information at the desired bit rate specified by the bit rate controller 34. Here, the encoder/transcoder 36 uses the complementary transformation, i.e., wavelet coding, sub band coding or DCT coding. The output of the encoder/transcoder 36 is forwarded to the disk storage 38 to be stored therein.

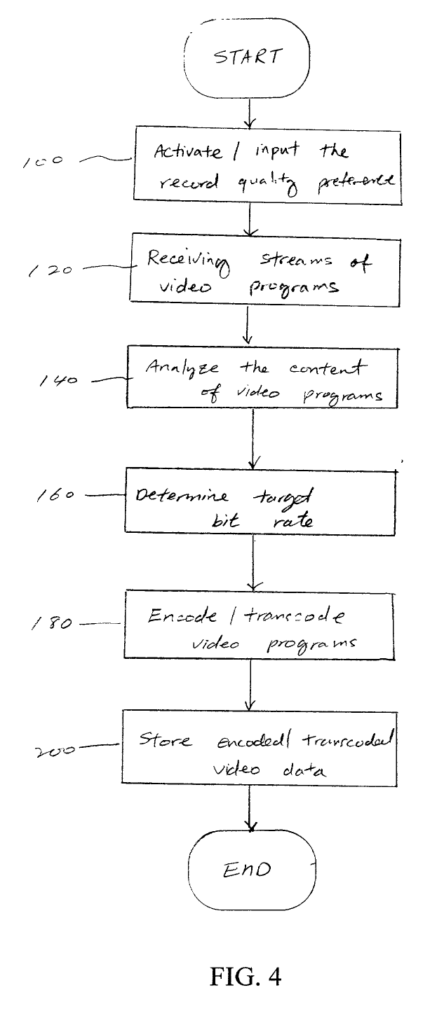

Referring to FIG. 4, a detailed description of the operation according to the present invention is provided. The method for automatically adjusting the quality setting is initiated in step 100. On the remote control interfacing with the present invention, a button like “SmartQuality” can be added to activate the automatic quality setting according to the present invention. Referring to FIG. 2, viewers can selectively specify the parameters that are used to set content-quality preferences in the initial step. Each category is assigned to different quality settings that the user desires, and each quality setting is assigned to different bit rates. Alternatively, a user can use a remote input device to directly set the recording quality for the incoming video information.

In step 120, video information is received, for example, from the conventional television (TV) broadcast. The received video information is classified according to the content of the incoming video programs in step 140. Content analysis can be performed in a variety of ways. As the incoming video information can be either plain video or compressed, the content analysis will be done either in the spatial domain or compressed domain. Then, the target bit rate depending on the analysis outcome or based on the amount of storage available is determined in step 160. If the incoming video is compressed (digital), the highest quality setting for recording should not exceed that of the incoming video as any additional amount of information used to represent the already compressed video will not yield any quality improvement. Thus, where compressed digital data is received, it will not be necessary to set it at high quality. Thereafter, either direct encoding or transcoding is performed in step 180 based on the format of the incoming video. Finally, the compressed data stream outputted from the encoder/transcoder is stored in a storage medium in step 200.

While the goal of the above scheme is to provide a method by which the data rate can be reduced, it is important to note that the reduced data stream generated during the quality setting mode operation should include sufficient data to support the same frame display rate supported during the standard play mode.

What is claimed is:

1. A method for automatically adjusting recording bit rates, the method comprising the steps of:
(a) receiving a plurality of video programs;
(b) concurrently with step (a), analyzing said video programs into a plurality of categories according to the contents of said video programs;
(c) determining target bit rates for the respective said video programs according to the corresponding analysis outcome; and, (d) encoding said video programs based on the corresponding target bit rates determined in step (c).

2. The method of claim 1, further comprising the step of storing said encoded video programs in a storage device.

3. The method of claim 1, wherein said target bit rates are determined according to predetermined criteria.

4. The method of claim 3, wherein said predetermined data is selectively changeable by a user.

5. The method of claim 1, wherein said target rates can be directly set by a user via a remote input device.

6. The method of claim 1, wherein the content of said video programs is analyzed into the plurality of said categories according to an electronic program guide (EPG) protocol.

7. The method of claim 1, wherein said video programs comprise conventional analog television signals, digital high definition television (HDTV), and digital standard definition television (SDTV) signals.

8. A method for automatically adjusting the recording quality of incoming video information, the method comprising the steps of:
(a) analyzing the content of said incoming video information into a plurality of categories according to predetermined criteria;
(b) determining compression rates for the respective video information according to the corresponding analysis outcome;
(c) compressing said incoming video information based on said determined compression rates; and, (d) storing said compressed incoming video information on a storage medium.

9. The method of claim 8, wherein the content of said video information is analyzed according to an electronic program guide (EPG) protocol.

10. The method of claim 8, wherein said video programs comprise conventional analog television signals, digital high definition television (HDTV), and digital standard definition television (SDTV) signals.

11. The method of claim 8, wherein said predetermined data is selectively changeable by a user.

12. The method of claim 8, wherein said analyzing step (a) comprises the step of analyzing an electronic program guide (EPG) information included in said incoming video information.

13. The method of claim 8, wherein said compression rates can be directly set by a user via a remote input device.

14. An apparatus for automatically processing incoming video information, comprising:
means for analyzing the content of said incoming video information into a plurality of categories according to predetermined criteria;
means for determining a compression rate for said incoming video information according to predetermined criteria;
means for compressing said incoming video information based on said determined compression rate; and,
means for storing said compressed incoming video information.

15. The apparatus of claim 14, further comprising a control means for controlling said compressing means according to said compression rate determined by said determining means.

16. The method of claim 14, wherein said video programs comprise conventional analog television signals, digital high definition television (HDTV), and digital standard definition television (SDTV) signals.

17. The apparatus of claim 16, wherein said compression means comprises a first means for compressing said analog signals and a second means for compressing said digital signals.

18. The apparatus of claim 14, wherein the content of said video programs is analyzed according to an electronic program guide (EPG) protocol.

19. The apparatus of claim 14, wherein said analyzing step comprises the step of analyzing electronic program guide information included in said incoming video information.

20. The apparatus of claim 14, wherein said storing means is selected from a group consisting of a rewritable optical disk drive, a DVD drive, a magneto-optical disk drive, and a removable hard disk drive.

21. The apparatus of claim 14, wherein said determining means determines what portion of said storing means remains available for storing said video information provided to determine what compression rate is used to record said video information on said storing medium.

22. The apparatus of claim 14, further comprising a remote input device adapted to communicate with said apparatus to directly set said compression rates for said incoming video information.
